(19) United States
(12) Patent Application Publication
(10) Pub. No.: US 2019/0085689 A1
(43) Pub. Date: Mar. 21, 2019

(54) BOTTOM-SIDE SEPARATION OF AN OBJECT TO BE CUT OUT OF STONE

(71) Applicant: Heindl Energy GmbH, Stuttgart (DE)

(72) Inventor: Gerd Stenzel, Trossingen (DE)

(73) Assignee: Heindl Energy GmbH, Stuttgart (DE)

(21) Appl. No.: 16/075,285

(22) PCT Filed: Jan. 27, 2017
(86) PCT No.: PCT/EP2017/051838

§ 371 Date: Aug. 3, 2018

(30) Foreign Application Priority Data
Feb. 4, 2016 (DE) 10 2016 101 983.6

(51) Int. Cl. E21D 13/00; E21D 1/03; E21C 25/54

(52) U.S. Cl. CPC E21D 13/00; F03G 3/00; E21C 25/54; E21D 1/03

(57) ABSTRACT

There are provided a method for the bottom-side separation of a body which is to be worked out of rock (2000), in which a first part of the bottom surface of the body to be worked out of the rock (2000) is separated by removing the rock (2000) situated below the bottom surface, and a second part of the bottom surface is separated by replacing rock (2000) situated below the bottom surface with a layer system (140, 240, 440, 540) which has two unconnected separating layers (141, 142, 241, 242, 441, 442, 541, 542, 1310, 1320), with the result that the body to be worked out of the rock (2000) is supported in the region of this second part of its bottom surface by the layer system (140, 240, 440, 540), and a system (1000), which is suitable for carrying out such a method, for the bottom-side separation of a body to be worked out of a rock (2000), having an advancing unit (1100) for removing a rock layer, a discharge conveying unit (1200) for conveying away rock (2000) removed by the advancing unit (1100), a laying unit (1300) for laying a first separating layer (1310) and a second separating layer (1320) not connected to the first separating layer (1310), and a filling unit (1400) having at least one concrete feeder (1410) for filling the interspace between the bottom (1421) of the space, which is created by the removal of the rock layer, and the first separating layer (1310) with concrete, having at least one concrete feeder (1430) for filling the interspace between the roof (1441) of the space, which is created by the removal of the rock layer, and the second separating layer (1320) with concrete, and having a formwork (1450).

### TECHNICAL FIELD

The system described herein relates to separation of an object to be cut out of stone, and more particularly to a method and apparatus for separating an object to be cut out of stone.

### BACKGROUND OF THE INVENTION

The energy revolution in Germany and the massive development of renewable energies have resulted in a huge need for energy storage devices, in particular energy storage devices with very high storage capacity. One known promising concept from DE 10 2010 034 757 B4 in this regard consists of using potential energy storage devices in which a large mass is elevated relative to the earth's surface using a hydraulic fluid, for example water, in a hydraulic cylinder by way of pumping the hydraulic fluid through one or more lines such that the mass for practical purposes represents the piston which moves in the hydraulic cylinder, and such that energy is stored in the form of potential energy of the raised piston. In the process, the mass can be in the form of cut-out rock and the required hydraulic cylinder can be in the form of the stone surrounding the cut-out stone. The significant advantage of this design, wherein the piston diameters and lift heights can be hundreds of meters, lies in the very high storage capacity of the systems, which far exceeds the capacity of conventional storage power plants.

One of the problems that comes up in potential energy storage systems such as this is the development of a suitable procedure for separating the bottom surface of the piston, which always remains below the earth's surface during operation of the potential energy storage system, from the underlying base. This is also particularly difficult since on the one hand the high weight of the cutout piston is supported when there is no hydraulic fluid present, which calls for a large area of support but which raises the pressure required to initially lift the piston from a rest position.

It is therefore desirable to provide a mechanism for bottom-side separation of an object to be cut out of stone.

### SUMMARY OF THE INVENTION

According to the system described herein, bottom-side separation of an object to be cut out of stone includes having a first part of a bottom surface of the object cut out of stone be separated by removing the stone below the bottom surface, and a second part of the bottom surface be separated by way of successive replacement of the stone below the bottom surface with a layer system which includes two un-connected separating layers. The object to be cut out of the stone is supported by the layer system in the area of the second part of the bottom surface of the object.

The term “un-connected separating layers” is to be understood to mean that the object, when it is cut out of the stone, may be raised such that the distance between the unconnected separating layers changes without the structure of the separating layers changing—regardless of possible elastic reactions to a pressure change in this process. Un-connected separating layers may thus be in surface contact with one another provided that they may be separated from one another and do not adhere to one another or become fused together due to the pressure of the object that was cut out of the stone.

The separating layer should therefore be made of a material that adheres well to stone and/or concrete, is sealed against penetration of hydraulic fluid—in other words is normally water-tight. Two separating layer surfaces brought into contact with one another while under pressure, in particular under the pressure of the object cut out of the stone when the object is only supported on the second part of the bottom surface thereof, do not bond with one another or with an intermediate layer placed between the separating layers. Sheet metal layers may be particularly well-suited as a separating layer.

By replacing the stone in an area of the bottom surface of the object cut out of the stone with a layer system with separating layers in this way, on one hand sufficient support of the object cut out of the stone may always be ensured. On the other hand, the two un-connected separating layers ensure that the hydraulic fluid under pressure may penetrate between the layers so that the same force may be introduced in the second part of the bottom surface of the object cut out of the stone when the object is raised.

Accordingly, the bottom surface of the object to be cut out of the stone that is prepared according to the system described herein is formed sectionally into roof areas in which stone was removed and sectionally by the upper separating layers or intermediate layers connected thereto. The roofs then form the first part and the separating layers or the intermediate layers form the second part of the bottom surface of the object to be cut out of the stone in the terminology herein.

A preferred type of layer system may include two concrete layers and two separating layers disposed at the surface of a concrete layer facing the respective other concrete layer, so that the separating layer of one concrete layer is separated at the separating layer of the other concrete layer which it borders so that in the area of this second part of the bottom surface of the object to be cut out of the stone, the object is supported by the concrete layers and the separating layers disposed therebetween.

The removal of stone may be achieved using known methods from tunnel construction and tunneling technology, and machines such as tunnel boring machines. In connection with replacement of the stone, the stone may also be removed in this way. In some instances, just a few meters behind a point at which the stone is removed, the filling with the layer system is done from the lower concrete layer (i.e. at a deeper depth relative to the earth's surface with the separating layer disposed thereon) and from the upper concrete layer (i.e. at a shallower depth relative to the earth's surface) with the separating layer disposed underneath.

However, in cases of very hard and stable stone in particular, a layer system which only includes the two separating layers or only the two separating layers and if necessary elastic intermediate layers disposed therebetween, for example a non-woven fabric or a rubber mat, may be an acceptable choice. In this case, to remove the stone to be replaced, it is sufficient for a corresponding gap to be sawed into the stone, which may only need to be a few centimeters high, for example using a rope saw, the separating layers and any intermediate layers then being pulled into the gap and attached, for example fused at the edges and or on the surface, if necessary also gluing on one side with a resin, respectively in the area of the separating layers extending inside the gap.

In the use of such a sawing technology, a breakage of the stone after it is sawed may be prevented, in particular by optionally having a sled moved or pulled in afterward that applies a gel in the sawed gap for temporary stabilization. This may also make the pulling of the separating layers into the sawed gap considerably easier.

In an embodiment of the system described herein, the separation of the first part of the bottom surface of the object to be cut out of stone includes the following:
making a central tunnel;
making a peripheral tunnel which intersects the central tunnel at at least one point; and
making secondary tunnels which run parallel to one another, and which each produce a straight-line connection between the central tunnel and the peripheral tunnel so that a column web results between two secondary tunnels which are adjacent to one another.

The term “column web” thus refers to stone areas which initially remain between two secondary tunnels or between a secondary tunnel and the peripheral tunnel.

The central tunnel may be connected to the surface directly, for example, or by way of an access tunnel with shafts, or may be made indirectly accessible by way of an access tunnel which leads out of the stone mass from which the object is cut. In particular, when using an access tunnel it is also possible to first make the peripheral tunnel, which may be run circular, and then to build the central tunnel. This may have advantages when the peripheral tunnel is built since information about the geological characteristics of the stone may be collected on site, and this information may result in a preferred direction for the secondary tunnels and central tunnel to run since corresponding work is easier in the preferred direction or else may be done with less effort.

What must be noted here is that there may be inherent advantages if the peripheral tunnel does not run along a periphery of an object to be cut out, but rather somewhat inside a periphery line. This particularly applies if separation of the bottom of the object to be cut out occurs prior to cutting out the side areas thereof, which is advantageous since then the connection of the side areas to the stone surrounding the side areas may prevent the piston to be cut out from suddenly dropping due to insufficient supporting forces when the bottom is separated.

If a peripheral tunnel is made this way prior to separating the side areas, undesired effects or damage to the peripheral tunnel may occur when having to make a connection, and also damage to the column webs and secondary tunnels may occur if a necessary connection to the peripheral tunnel is made when separating the side surfaces from the top. Therefore, it is preferred to first leave behind a rock wall between the peripheral tunnel and the empty volume created from the separation of the side areas and then break through the wall by way of boring or sawing.

Further, in in an embodiment of the system described herein, separating the second part of the bottom surface of the object to be cut out of the stone is done by replacing at least one stone layer of each column web with an upper concrete layer bordered downward by a first separating layer connected to the upper concrete layer and a lower concrete layer bordered upward by a second separating layer connected to the lower concrete layer. Optionally, in one or both of the concrete layers, reinforcements, cooling pipes and/or drainage pipes may be embedded and/or expansion joints may be provided as required.

Of course, an entire column web may be replaced by a layer system so constructed, but it may also be that stone areas of the column web remain above and/or below the layer system.

Stone areas of the column web remain above and/or below the layer system in instances when a corresponding gap is sawed into the stone to remove the stone to be replaced, the gap possibly only needing to be a few centimeters high, for example using a rope saw, the separating layers and any intermediate layers present then being pulled into the gap and attached, for example fused at the edges and or on the surface, if necessary also glued on one side with a resin, respectively, in the area of the separating layers extending inside the gap. If this process is carried out at column webs, the option is created by pulling in the layer system of the separating layers from secondary tunnels into the sawed gap, which may represent a significant simplification due to a much shorter distance which must be traversed in a gap by a layer system from this direction when being pulled in in comparison to pulling in in the direction in which the column web runs between the central tunnel and the peripheral tunnel.

The system described herein may be carried out with much less effort if the direction in which the central tunnel and/or secondary tunnels run is aligned with geologic characteristics of the stone, in particular along fissures in the stone, since this may substantially reduce effort needed to remove stone in particular.

The secondary tunnels may be used to remove the stone to be replaced to the column webs during replacement of the stone. In some embodiments this may be done only in every other one of the secondary tunnels.

Moreover, in some embodiments an installation is provided in the secondary tunnels, the purpose of the installation being to feed a flushing fluid on the one hand, for example in order to process the stone at the point of its removal or point of advancement in the presence of the fluid, for example for cooling and/or for dust suppression, and on the other hand to be able to discharge fluid, in particular the flushing fluid, after use.

Concrete that is used for replacement of stone may be fed in from a concrete supply source at a fixed location, in some cases in the central tunnel, for example a concrete silo or a concrete preparation system, over an essentially flat line system, extendable if necessary, for example a piping or hose system, such as those known from concrete pump systems.

In this regard, in order to keep the logistical demand for removal and feed-in of material as low as possible, in some cases, at least some of the removed and/or replaced stone is used to prepare the concrete needed to replace the stone. For example, the stone may be broken up in the central tunnel and then further processed in a concrete preparation system located in the central tunnel.

In some embodiments, an upper and a lower border surface of the stone layer to be replaced is defined in the column webs by way of a sawing process before replacing the stone. This is possible using rope saws, for example—if necessary with the use of a liquid during sawing. This pre-sawing produces a defined break-off edge when replacing the stone, which leads in particular to improved adhesion of the concrete to the stone and good heat dissipation during concrete curing.

In some embodiments, replacement of the stone layer is carried out as follows:
removing a stone layer in a section of a column web,
carrying away the stone so removed,
laying the first separating layer and the second separating layer, and
filling in with concrete the intermediate space between the roof of the space created by the removal of the stone layer in a section of the column web and the first separating layer, and filling in with concrete the intermediate space between the roof of the space created by the removal of the stone layer in a section of the column web and the second separating layer.

In the system described herein, the lower separating layer which may bear or support an upper separating layer in a processing stage may be supported, particularly during the laying, for example by pushing in supports from a secondary tunnel. When the first separating layer and the second separating layer are laid, it may also be optional for another intermediate layer, for example a non-woven material or rubber mat layer, to be laid as well.

In an embodiment herein, the steps are carried out on an ongoing basis inside a column web—i.e., directly after the section of the column web is processed in the last respective step and at least parallel with one another in time at different points in the column web.

In other words, the removal of the stone layer begins with a tunnel boring machine or a stone mill, for example, at the end of the column web bordering the central tunnel, and is continued from there in ongoing advancement in a direction of a peripheral tunnel. In an area directly next to the tunnel being bored and opposite to the direction of advancement, the removed material is carried away. A bit further opposite to the direction of advancement, the separating layers are laid and if necessary supported, while even further opposite the direction of advancement in a section put in place for this purpose, the concrete filling is already taking place even as the tunnel boring machine or stone mill continues to operate. It should be noted that in this procedure, except for the beginning of the work, one end of the separating layers to be laid is always already embedded in concrete at a new column web at the intended height, which is why the lower separating layer does not come into contact with the bottom during the laying of the separating layers even when the lower layer is not supported, provided that the distance between the already filled area and the location at which the separating layers are currently being laid is not too large.

In some embodiments, the replacement of the stone in column webs adjacent to one another to be carried out in mutually opposing advancement directions. To this end, the system, which is made up of a plurality of machines or devices, is directed to a column web in the peripheral tunnel or the central tunnel at the end of each work step and is re-purposed for the column web to be processed next, which may be implemented quite easily using modular systems.

In some embodiments, at least one separating layer laid has a surface structuring, such a grooves or channels, and possibly a continuous structuring in particular in the direction of advancement, and/or has an intermediate layer between the separating layers, the intermediate layer being porous or having a surface structuring, in particular a structuring which is continuous in the direction of advancement.

Such a structuring which is continuous in the direction of advancement may be present in particular when hydraulic fluid may flow through the surface structures from the central tunnel to the peripheral tunnel when the separating layer is laid. Such a surface structuring may facilitate the introduction of force to the second part of the bottom surface in an initial lifting phase of the object to be cut out of the stone when the hydraulic fluid is pumped in. The same effect may be achieved using a porous intermediate layer between the separating layers.

The system described herein for the bottom-side separation of an object to be cut out of a stone includes at least the following components:
an advancing unit for removing a stone layer,
a discharge conveying unit for carrying away stone removed by the advancing unit,
a laying unit for laying a first separating layer and a second separating layer not connected to the first separating layer, and
a filling unit with at least one concrete feed unit for filling with concrete the intermediate space between the roof of the space created by the removal of the stone layer and the first separating layer, at least one concrete feed unit for filling with concrete the intermediate space between the roof of the space created by the removal of the stone layer and the second separating layer, and with a form.

Here, a known tunnel boring or tunnel advancing machine may be used as the advancing unit.

The discharge conveying unit may be a conveyor belt system, for example, the transport direction of which is substantially perpendicular relative to a tunnel advancement direction and directed toward secondary tunnels or which includes at least one component (in the vectorial sense) in the direction toward a secondary tunnel perpendicular to the tunnel advancement direction so that with the conveyor belt system the stone removed by the advancing unit may be conveyed from the area of the column web to the secondary tunnel, from where the stone may then be further conveyed to the central tunnel using a conveyor belt system. The discharge conveying unit may also be integrated into the advancing unit if necessary.

The laying unit includes a material supply for the first and the second separating layer, which may be designed using corresponding rolls of separating layer material so that when the laying unit moves in a direction of advancement, the separating layers are rolled out. It may be useful to anchor the beginning of the separating layers in the tunnel from which the advancement proceeds, depending on the current direction of advancement, for example in a (concrete) lining of the central tunnel or peripheral tunnel. If a section of the column web has already been re-filled, the section of the separating layer located therein may be bonded to the concrete and hence likewise affixed. Accordingly, at every time in the process of laying the separating layers, a section of the separating layers between such a fixed point and the current roll-off point is either substantially self-supporting in the space or the section is supported by a support device which may, for example, be pushed in laterally from the direction of the secondary tunnels.

The filling unit includes at least one concrete feed unit as a component for filling with concrete the intermediate space between the bottom of the space created by the removal of the stone layer and the first separating layer. The filling unit also includes at least one concrete feed unit for filling with concrete the intermediate space between the roof of the space created by the removal of the stone layer and the second separating layer and a least one form for ensuring that the concrete filled into the spaces created by the removal of the stone layer, the spaces being separated from one another by way of separating layers, cures in the form of the corresponding section of the column web.

It goes without saying that there are access openings made in the form for the separating layers and the concrete feed units.

It must be noted that the concrete feed unit for filling with concrete the intermediate space between the bottom of the space created by the removal of the stone layer and the first separating layer and the concrete feed unit for filling with concrete the intermediate space between the roof of the space created by removal of the stone layer and the second separating layer does not necessarily have to be designed in such a way that both spaces may be filled simultaneously, so that this feature is also implemented when, for example, a concrete line is only connected to a fill nozzle which passes through a form wall to one space and then, after this space is filled, is connected to a fill nozzle which passes through a form wall to the other space.

In some embodiments, There is a space between the discharge conveying unit and/or the advancing unit on the one hand and the laying unit and/or the filling unit on the other hand. The space is accessible from the secondary tunnels. This may be very useful, for example, if there are problems with the discharge, if technical access to the advancing unit is required, if the concrete feed unit is not functioning properly or if access to the laying unit is required, for example to replace separating layer rolls.

As discussed elsewhere herein, it is possible to execute the different processing steps for replacing the stone in a column web at different points within the column web at the same time. In order to implement this, it is advantageous for at least one advancing unit, at least one discharge conveying unit, at least one laying unit or at least one filling unit to be designed to be movable, which is the case in particular when the unit is disposed on a tracked vehicle. It is useful to structure all of the units to be movable, in particular commonly movable.

However, in some embodiments, the advancing unit, the discharge conveying unit, the laying unit and/or the filling unit are separable from one another, i.e. not inseparably connected together. The reason for this is that in this way, the process may be carried out in an efficient way using the system, where the replacement process is carried out in column webs which are adjacent to one another in opposite advancement directions without it being necessary to build a peripheral tunnel and secondary tunnels with a large cross sectional area or diameter since the individual units may be taken apart one after the other and then turned around.

Similarly, it is also posible for the system to include at least two or more advancing units, and also at least two discharge conveying units, respectively, two laying units or filling units, where similar kinds of units may be connected together modularly such that the units may be placed in parallel with one another in the same cutting plane. In this way, not only may a curvature of the peripheral tunnel be utilized, but also the tunnel diameter required to rotate the system during a transition to the next column web may be kept small.

However, it should be noted that it is also possible to transport machines having a working width corresponding to the width of a column web back to the central tunnel using the peripheral tunnel, so that a modular design as such is not necessarily required. For example, rolls of separating layers may be provided in lengths that are pre-tailored to the length of the corresponding column web and any support structures for these rolls may then be carried away using the peripheral tunnel. The next separating layer roll used for processing the next column web is then fed in by a secondary tunnel and brought to the layout position after the advancing units have worked their way sufficiently far enough into the column web in order to allow introduction of the separating layer roll.

In some embodiments, at least one advancing unit, at least one discharge conveying unit, at least one laying unit and/or at least one filling unit support a tunnel wall and/or brace a tunnel wall, using, for example, dies that may be operated hydraulically, struts and/or tension straps.

### BRIEF DESCRIPTION OF DRAWINGS

The system described herein is explained in more detail below with the aid of figures showing exemplary embodiments.

FIG. 1 is a schematic representation of the structures to be generated at the bottom surface of the object to be cut out of the stone according to the system described herein.

FIG. 2 is a schematic representation of a sawing process, with a rope saw at a column web in a cutting plane, according to the system described herein.

FIG. 3 is a schematic cross sectional representation of a system for bottom-side separation of an object to be cut out of a stone, viewed from a secondary tunnels, according to the system described herein.

FIG. 4 is a sketch illustrating the modular construction of a system, as seen from above, for the bottom-side separation of an object to be cut out of a stone, according to the system described herein.

FIG. 5a is a schematic representation of a first partial step of a variant of the replacing of a stone layer in a column web in which the removal of the stone to be replaced is done using a rope saw, from the point of view of a secondary tunnels, according to the system described herein.

FIG. 5b is a schematic representation of a second partial step of a variant of the replacing of a stone layer in a column web in which the removal of the stone to be replaced is done using a rope saw, from the point of view of a secondary tunnels, according to the system described herein.

FIG. 6a is a cross section of a column web after replacement of a stone layer sawed out by a first layer system, according to the system described herein.

FIG. 6b is a cross section of a column web after replacement of a stone layer sawed out by a second layer system, according to the system described herein.

FIG. 6c is a cross section of a column web after replacement of a stone layer sawed out by a third layer system, according to the system described herein.

FIG. 6d is a cross section of a column web in which the stone forming the column web is completely replaced by a fourth layer system, according to the system described herein.

### DESCRIPTION OF VARIOUS EMBODIMENTS

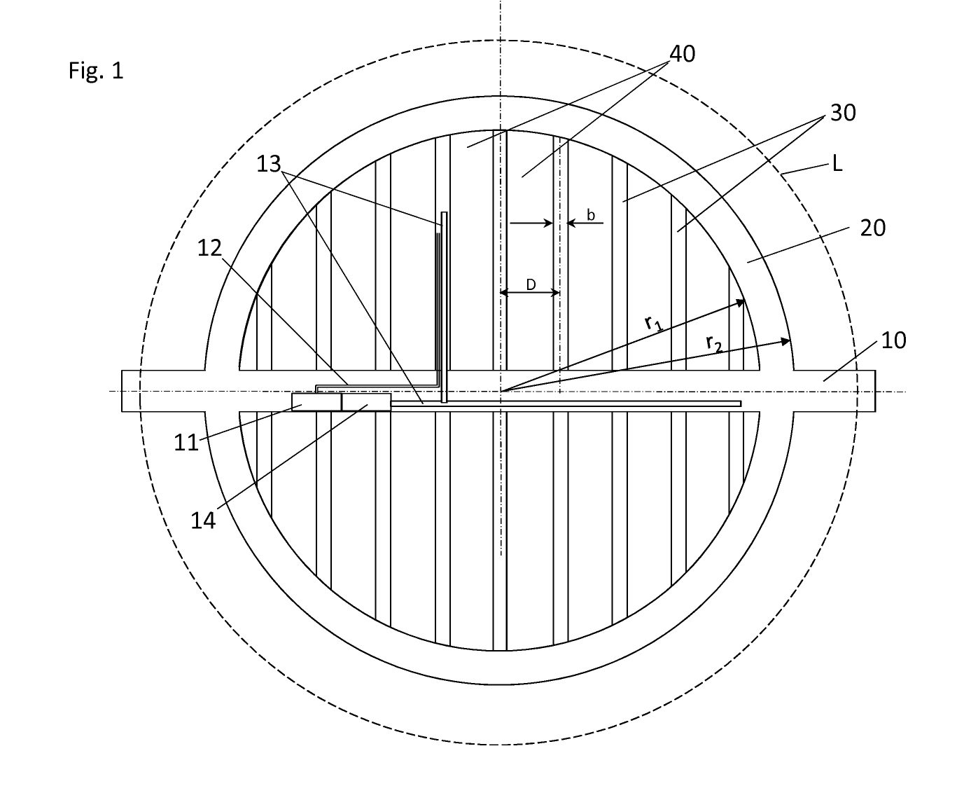

FIG. 1 shows a schematic representation of the structures to be created through stone removal at the bottom surface of the object to be cut out of the stone, the structures commonly forming the first part of this bottom surface. Shown here is a view from below at a point in time at which the side walls of the object to be cut out of the stone have not yet been separated, the future wall profile sketched by a dashed line L. This corresponds to a preferred construction sequence since the separation of the bottom surface of the object is then possible without risk since the side walls are still surrounded by the peripheral stone.

A central tunnel 10 may be seen, and a peripheral tunnel 20 which in this exemplary embodiment runs in a circle, with an inner radius rl of 112.5 m and an outer radius r2 of 125 m, and secondary tunnels 30 running parallel to one another with a tunnel width b which may be 5 meters, for example. The secondary tunnels 30 in this example run at right angles to the central tunnel 10, where the respective centerlines m of two secondary tunnels 30 adjacent to one another run at a distance D from one another, which may be 25 meters, for example. The central tunnel 10 may be made accessible by way of shafts or an access tunnel, which are not shown.

An optional locally-fixed concrete supply unit 11, for example in the form of a concrete silo, may be disposed in the central tunnel 10 and for conveying material therefrom through a flexible line system 12 which is laid into a respective secondary tunnel 30 currently needing concrete and which may be extended if necessary, and which in FIG. 1 leads to a selected secondary tunnel 30 but which may be laid into other secondary tunnels 30 as the need arises. The line system 12 should run as flat as possible.

Furthermore, a conveyor belt system 13, which may also be adaptable as necessary, may be disposed in the central tunnel 10 to carry away removed or replaced stone, and which also leads into a secondary tunnel 30, where the conveyor belt system 13 may be retrofitted such that the conveyor belt system 13 leads into another secondary tunnel 30 or else branches off so that the conveyor belt system 13 may lead into a plurality of secondary tunnels 30.

As an option, the removed or replaced stone may also be broken up using a crushing system 14 disposed in the central tunnel and used directly to produce concrete in the concrete supply unit 11 so as to reduce transport requirements.

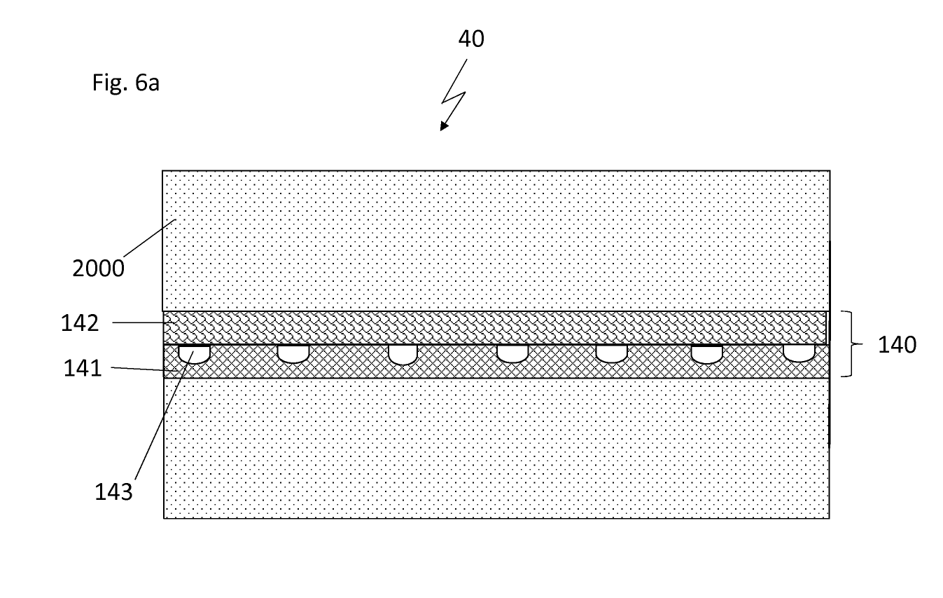

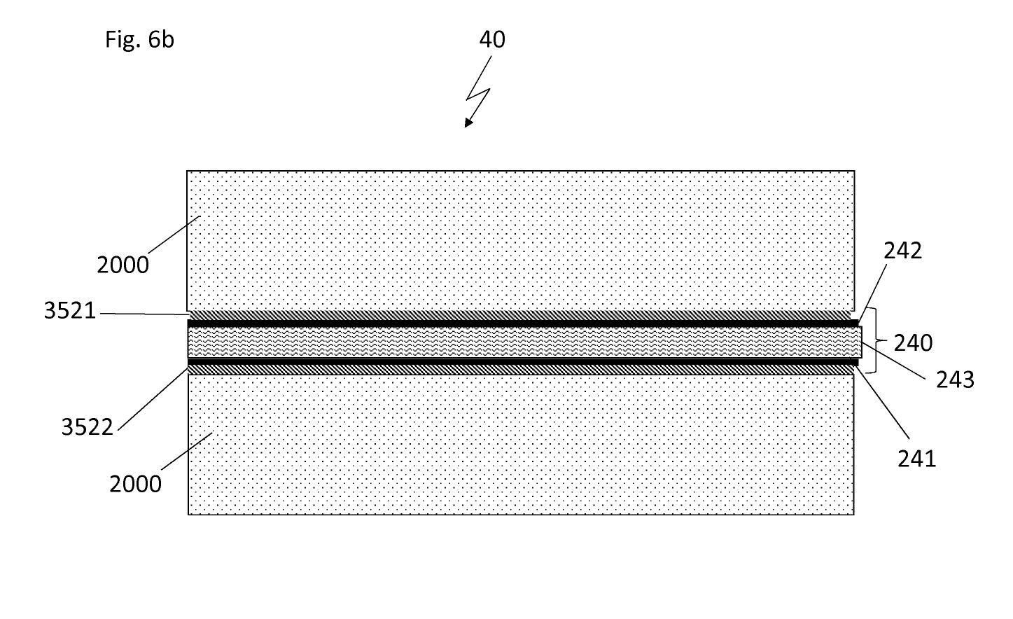

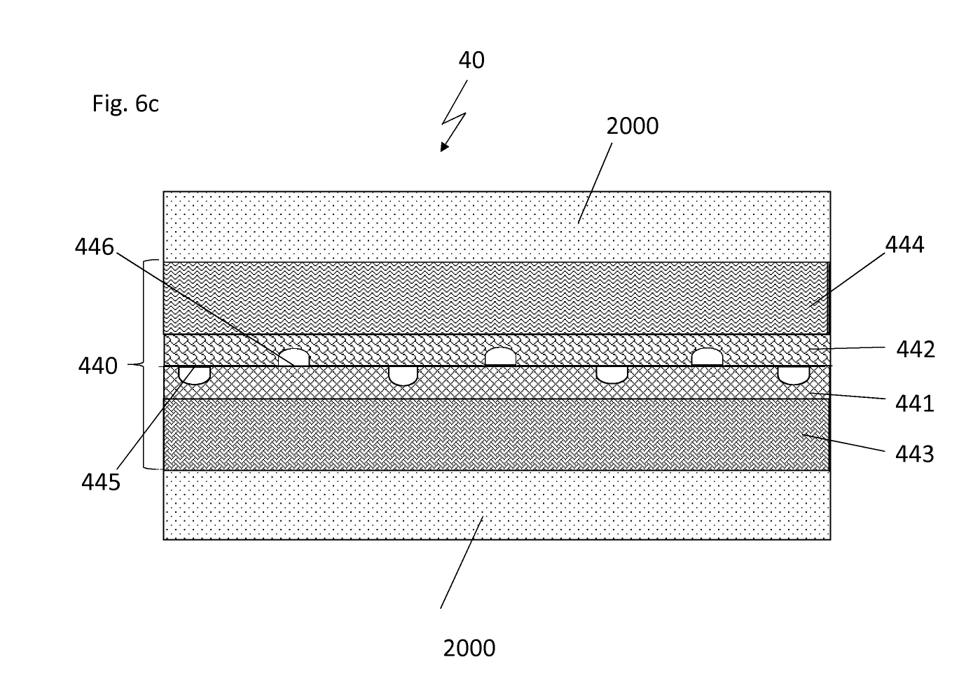

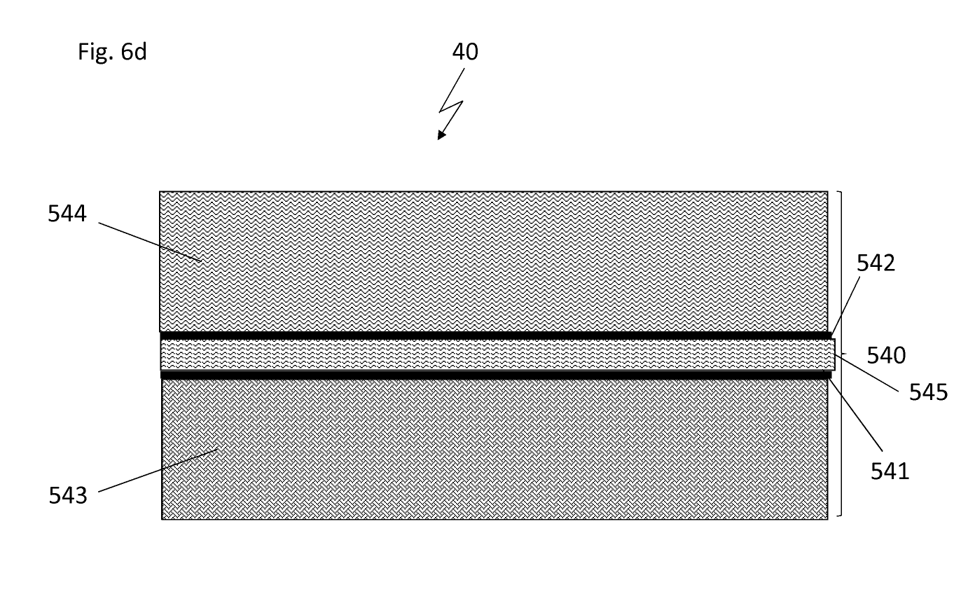

Between the secondary tunnels 30, there initially remain stone connections between the bottom surface of the object to be cut out of the stone and the surrounding stone, namely the column webs 40. In the area of these column webs, the second part of the bottom surface is then separated by replacing stone lying beneath the bottom surface using a layer system which includes two un-connected separating layers which do not lie in the plane shown in FIG. 1 and therefore are not seen in FIG. 1. Examples of such layer systems and their arrangement in a column web are explained further below with the aid of FIGS. 6a to 6e.

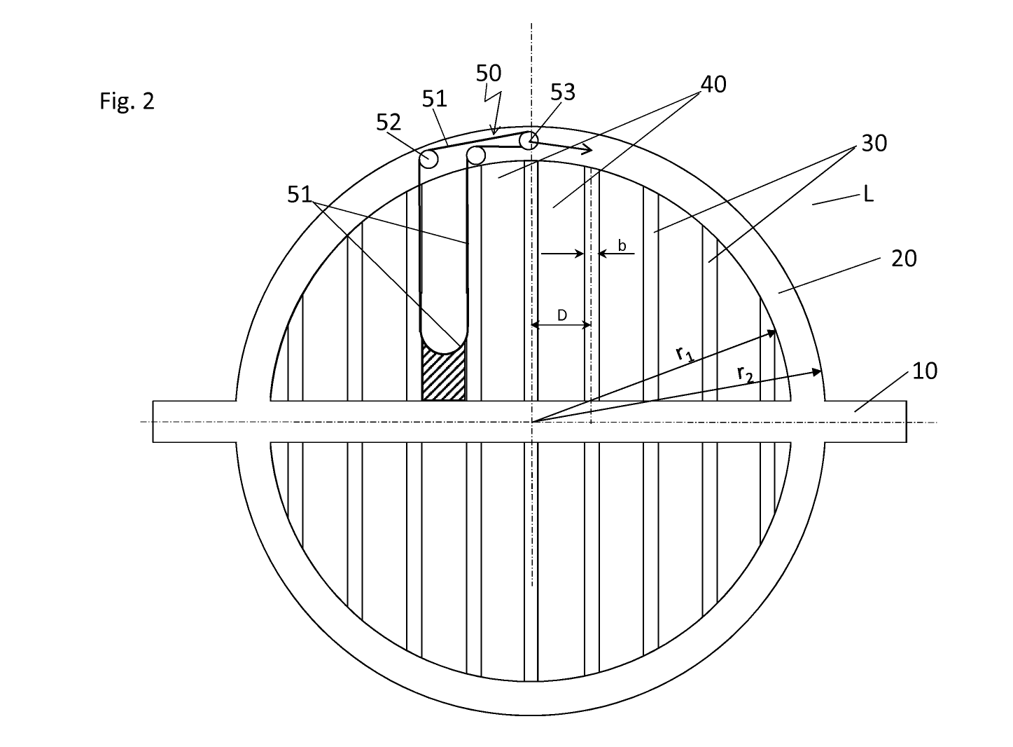

FIG. 2 shows a schematic representation of a cutting process, with a rope saw 50 comprising a cutting rope 51, guide pulleys 52 and a drive pulley 53 at a column web. The direction of view in FIG. 2 is identical to that in FIG. 1, but the cutting plane shown is within the current cutting plane of the rope saw 50.

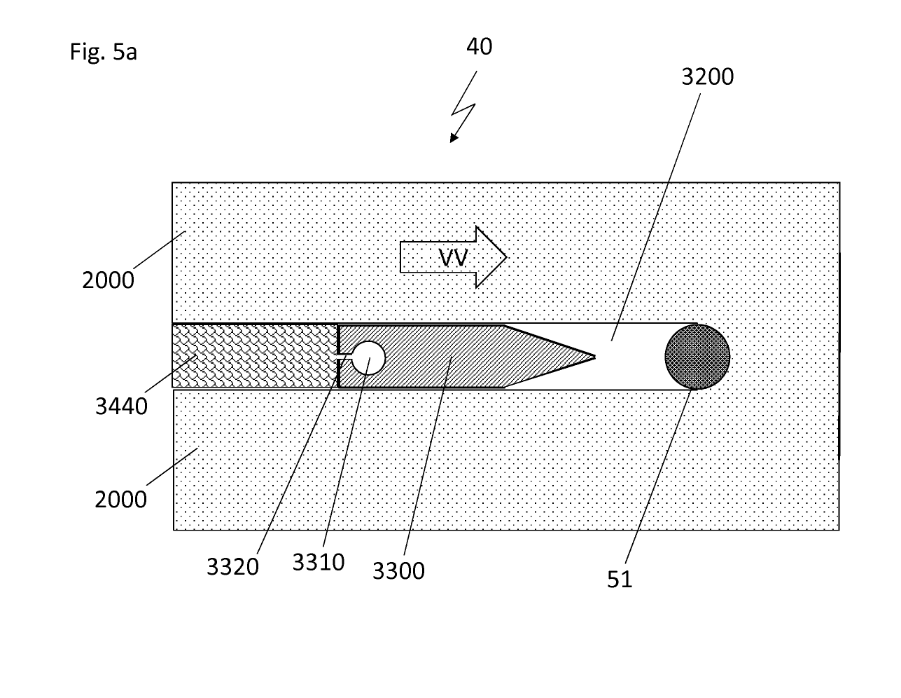

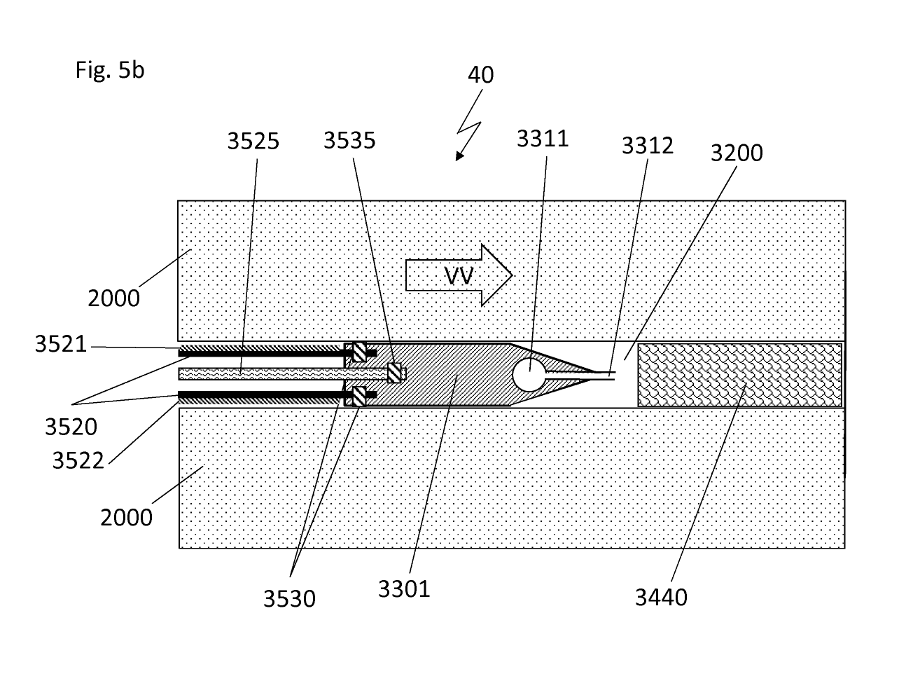

Such cutting processes may on one hand be used in very stable stone in the manner shown as an example in FIGS. 5a and 5b to pull a layer system into the gap created, which may be temporarily stabilized as an option by introducing a gel, the layer system having two separating layers and an optional intermediate layer. Such layer systems are represented further below and in FIGS. 6a to 6c as examples.

On the other hand, such cutting processes may also be carried out at the height of the upper edge and/or the lower edge of a stone layer to be removed prior to the removal thereof in order to keep the roof and/or the bottom of the space created from the removal of a stone layer relatively smooth and free of broken edges. In many types of stone, and when replacing a thicker stone layer with a correspondingly thicker layer system which also includes concrete layers in particular, such as the layer systems shown in FIGS. 6d and 6e, for example, this may contribute to facilitating an improved connection of the concrete layers to this roof or bottom.

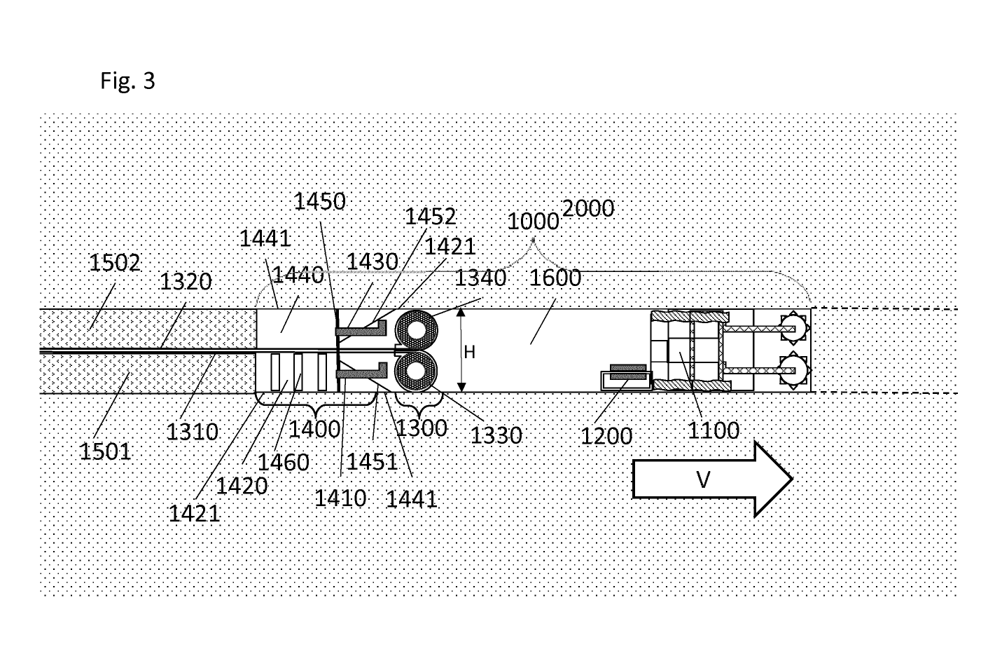

FIG. 3 shows a schematic cross-sectional representation of a system 1000 for bottom-side separation of an object to be cut out of a stone 2000, viewed from the perspective of a side tunnel 30, the system able to replace such thicker stone layers of height H, which may be 2 m, for example, using such a thicker layer system. Here, the system 1000 works its way through the stone 2000 of a column web 40 in the advancement direction V.

The system 1000 is made up of
an advancing unit 1100 for removing a stone layer, the unit being designed as a tunnel boring machine,
a discharge conveying unit 1200 for carrying away stone removed by the advancing unit 1100, the conveying unit being designed as a conveyor belt,
a laying unit 1300 for laying a first separating layer 1310 and a second separating layer 1320 not connected to the first separating layer 1310, including a first separating layer supply roll 1330 and a second separating layer supply roll 1340, and a filling unit 1400 including a concrete feed unit 1410 for filling with concrete the intermediate space 1420 between the bottom 1421 of the space created by the removal of the stone layer and the first separating layer 1310, and including a concrete feed unit 1430 for filling with concrete the intermediate space 1440 between the roof 1441 of the space created by the removal of the stone layer and the second separating layer 1320, and including a form 1450 which closes off the intermediate spaces 1420, 1440 in the advancement direction and in the direction toward the secondary tunnels 30, thereby defining the form volume closed off in the direction opposite to the direction of advancement by the already cured concrete layers 1501, 1502.

In the embodiment according to FIG. 3, supports 1460 are provided in the form volume, more precisely in the intermediate space 1420, for supporting the first separating layer 1310, where the supports may be pushed in from the side from the secondary tunnel 30 and remain with the concrete. Also shown in the exemplary embodiment of FIG. 3 is a space 1600 between the discharge conveying unit 1200 and the advancing unit 1100 on one side and the laying unit 1300 and the filling unit 1400 on the other side, the space being accessible from the secondary tunnel 30.

The form 1450 is supported by struts 1451, 1452 in the area outside the form volume at the roof 1421 and bottom 1441.

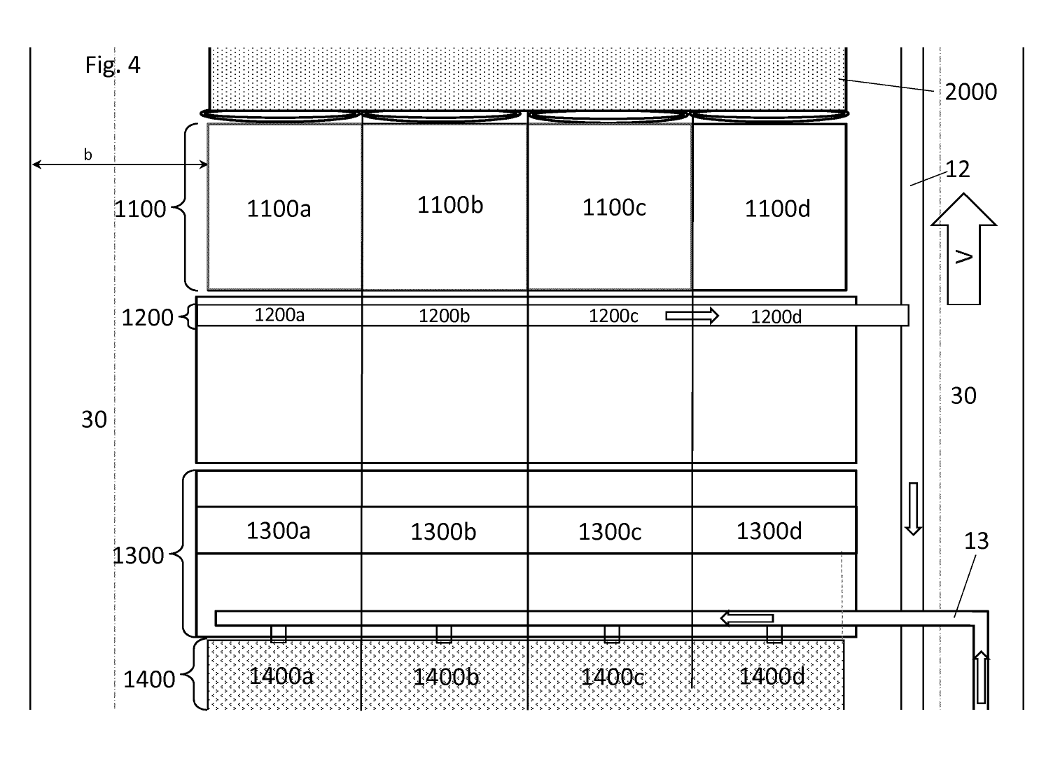

FIG. 4 is a sketch illustrating the modular construction of a system 1000, as seen from above, for the bottom-side separation of an object to be cut out of a stone. It may be seen that the advancing unit 1100, the discharge conveying unit 1200, the laying unit 1300 and the filling unit 1400 are modularly composed of four advancing unit modules II00a-d, four discharge conveying unit modules 1200a-d, four laying unit modules 1300a-d and four filling unit modules 1400a-d, respectively, disposed in a direction perpendicular to the advancement direction next to one another in a plane in which the secondary tunnels 30 lie, which enables the system to be turned around at the end of a column web 40 for processing the next column web 40 even in relatively narrow spaces.

FIGS. 5a and 5b show a schematic representation of a variant for replacing a stone layer 2000 in a column web 40 in which the removal of the stone to be removed is done using a rope saw 50, viewed from a secondary tunnel 30.

In a first step shown in FIG. 5a, a gap 3200 is sawed in the stone 2000 of a column web 40 using the cutting rope 51, wherein a first transport bar 3300 is optionally trailed—for example pulled or pushed from behind—into the gap, the transport bar comprising a feed line 3310 for a gel fluid 3440 and a gel nozzle 3320 at the side of the bar opposite to the sawing direction VV, the gap 3200 being filled from the nozzle with gel fluid 3440. Here, the sawing direction through the stone 2000 of the column web 40 may also be the direction of a secondary tunnel 30 relative to an adjacent secondary tunnel 30.

In the second step shown in FIG. 5b, a second transport bar 3301 is then led in the sawing direction VV or in the direction opposite thereto through the gap 3200 sawed using the rope saw 50. At the front side of the transport bar 3301 in the direction of motion, there is a flushing nozzle 3312 which feeds a flushing fluid through a feed line 3311 in the case where a gel fluid 3440 had been fed to the sawed gap 3200 for the stabilization thereof so as to dissolve the gel.

Fastened to the side of the transport bar 3301 opposite to the direction of motion using fastening elements 3530, there are sealing tracks 3520, each of which includes an adhesive coating 3521, 3522 on the side of the respective element facing the stone 2000. Disposed between the sealing tracks 3520 is a non-woven material 3525 or a studded rubber mat, the material being fastened to the transport bar 3301 using a fastening element 3535. This layer system may thus be pulled into the gap 3200 by moving the transport bar 3301.

Below, with the aid of FIGS. 6a to 6e different variants of layer systems after the replacement of a stone layer of a column web 40 by the respective layer system are presented.

FIG. 6a shows a cross section of a column web 40 after replacement of a sawed out stone layer by a first layer system 140, consisting of two separating layers 141, 142, namely a lower separating layer 141 and an upper separating layer 142 which directly border one another. The lower separating layer 141 has a surface structuring in the form of grooves 143.

FIG. 6b shows a cross section of a column web 40 after replacement of a sawed-out stone layer by a second layer system 240, consisting of two separating layers 241, 242, namely a lower separating layer 241 and an upper separating layer 242, between which an intermediate layer in the form of a porous non-woven material 243 disposed directly bordering the separating layers 241 and 242. The separating layers 241 and 242 are each provided with optional adhesive coatings 3521, 3522 on the side of the layers facing the stone 2000. Instead of an intermediate layer in the form of the porous non-woven material 243, a studded rubber mat may also be used which is placed at the same location.

FIG. 6c shows a cross section of a column web 40 after replacement of a sawed out stone layer by a third layer system 440, consisting of two concrete layers 443, 444, namely a lower concrete layer 443 and an upper concrete layer 444, and two separating layers 441, 442 disposed at the surface of a respective concrete layer 443, 444 facing in the direction of the other respective concrete layer 444, 443, namely a lower separating layer 441 and an upper separating layer 442, each of which has a surface structure in the form of grooves 445, 446.

FIG. 6d shows a cross section of a column web 40 in which the stone forming the column web 40 is completely replaced by a fourth layer system 540, consisting of two concrete layers 543, 544, namely a lower concrete layer 543 and an upper concrete layer 544, and two separating layers 541, 542 each disposed at the surface of a concrete layer 543, 544 facing in the direction of the respective other concrete layer 544, 543, namely a lower separating layer 541 and an upper separating layer 542, as well as an intermediate layer 545 disposed therebetween which may again be designed as porous, for example as a non-woven fabric or with a surface structuring which is continuous in the advancement direction, for example as a grooved or studded rubber mat.

Other embodiments of the invention will be apparent to those skilled in the art from a consideration of the specification and/or an attempt to put into practice the invention disclosed herein. It is intended that the specification and examples be considered as exemplary only, with the true scope and spirit of the invention being indicated by the following claims.

1. A method for bottom-side separation of an object to be cut out of stone, comprising:
separating a first part of the bottom surface of the object to be cut out of the stone by removing the stone below the bottom surface; and
separating a second part of the bottom surface by replacing the stone below the bottom surface with a layer system having two un-connected separating layers, so that the object to be cut out of the stone is supported in an area of the second part of the bottom area by the layer system.

2. The method according to claim 1, wherein the layer system includes two concrete layers and two separating layers disposed at a surface of one of the concrete layers which faces in a direction of an other one of the concrete layers.

3. The method according to claim 1, wherein separation of the first part of the bottom surface of the object to be cut out of stone includes:
making a central tunnel;
making a peripheral tunnel which intersects the central tunnel at at least one point; and
making secondary tunnels that run parallel to one another, each of which produces a straight line connection between the central tunnel and the peripheral tunnel so that a plurality of column created between pairs of the secondary tunnels which are adjacent to one another, wherein separation of the second part of the bottom surface of the object to be cut out of the stone is achieved by replacing at least one stone layer of each column of the column webs with the layer system having two un-connected separating layers.

4. The method according to claim 3, wherein a direction in which the central tunnel and/or the secondary tunnels run is aligned with geologic properties of the stone.

5. The method according to claim 2, concrete used for replacing the stone is fed in from a locally fixed concrete supply unit through a substantially flat line system which is extendable.

6. The method according to claim 2, wherein at least some removed and/or replaced portions of the stone are used to prepare concrete that replaces the stone.

7. The method according to claim 3, wherein before replacing the stone, an upper border surface and a lower border surface of the stone layer to be replaced is defined in the column webs by sawing processes.

8. The method according to claim 3, wherein replacing the stone layer includes:
removing a stone layer in a section of a column web,
carrying away portions of the stone so that has been removed,
laying a first separating layer and a second separating layer, and
filling with concrete an intermediate space between a bottom of space created by removal of the stone layer in a section of one of the column webs and the first separating layer and filling with concrete the intermediate space between a roof in space created by removal of the stone layer in the section of one of the column webs and second separating layer.

9. The method according to claim 8, wherein the first separating layer is supported prior to applying concrete.

10. The method according to claim 3, wherein replacing the stone is performed in ones of the column webs that are adjacent to one another in advancement directions that are opposite to one another.

11. The method according to claim 1, wherein at least one of the separating layers is laid which has a continuous structuring in an advancement direction, and/or an intermediate layer is disposed between the separating layers which is porous or which has a continuous structuring in the advancement direction.

12. A system for bottom-side separation of an object to be cut out of stone, comprising:
an advancing unit for removing a stone layer;
a discharge conveying unit for carrying away stone which is removed by the advancing unit;
a laying unit for laying a first separating layer and a second separating layer that is not connected to the first separating layer; and
a filling unit having at least one concrete feeding unit for filling an intermediate space between a bottom of space created by removal of the stone layer and the first separating layer, the at least one concrete feeding unit filling an intermediate space between a roof of space created by removal of the stone layer and the second separating layer and a form.

13. The system according to claim 12, wherein the advancing unit, the discharge conveying unit, the laying unit or the filling unit is disposed on a tracked vehicle.

14. The system according to claim 12, wherein the advancing unit, the discharge conveying unit, the laying unit or the filling unit support or brace a tunnel wall.

15. The system according to claim 12, further comprising:
at least two or more advancing unit modules that are modularly connectable with one another and placed in parallel relative to one another in a same cutting plane.

16. The method according to claim 4, wherein the direction in which the central tunnel and/or the secondary tunnels run is aligned with fissures in the stone.

17. The system according to claim 12, further comprising:
at least two or more discharge conveying unit modules, laying unit modules or filling unit modules that are modularly connectable with one another and placed in parallel relative to one another in a same cutting plane.
